(19) United States
(12) Patent Application Publication
(10) Pub. No.: US 2004/0103186 A1
(43) Pub. Date: May 27, 2004

(54) Platform and method for monitoring and analyzing data

(76) Inventors: Fabio Casati, Palo Alto, CA (US); Ming-Chien Shan, Saratoga, CA (US); Umeshwar Dayal, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/302,178

(22) Filed: Nov. 21, 2002

(51) Int. Cl. G06F 15/173

(52) U.S. Cl. 709/224

(57) ABSTRACT

A platform for implementing a method for monitoring and analyzing data includes a user defined data repository and in which a user may create a user defined data structure; a graphic user interface coupled in data exchanging relation relative to the data repository; a monitoring and analysis engine coupled in data exchanging relation relative to the graphic user interface and the data repository; and data input manager coupled in data exchanging relation relative to the data repository; and wherein the platform permits a use to define a plurality of user defined metrics associated with the user defined data structure; and which further aggregates the plurality of metrics at different levels of abstraction by utilizing the user defined data structure.

### FIELD OF THE INVENTION

The present invention relates to a platform and method for monitoring and analyzing data, and more specifically to a platform which permits a user to dynamically define a data repository and thereafter perform a user defined analysis of the data repository across various user defined levels of abstraction.

### BACKGROUND OF THE INVENTION

The delivery of web services promises to be the next wave of Internet-based applications.

There has been a strong emphasis by software vendors and service providers, as of late, to implement web service-oriented architectures that will provide a means by which companies can expose their offerings as web services.

In today's economy, the Internet is not only being used to provide information and perform simple e-commerce transactions but is also being used as a platform through which services are delivered to businesses and customers.

In this regard, services delivered by way of the Internet have typically been referred to as “e-services,” while the term, “web service” refers normally to an e-service delivered using standard web technology such as HTTP, XML, and SOAP. According to several market research firms, it is extremely likely that before the year 2005, many companies' offerings will be available as web services. In fact, the delivery of web services has recently been enhanced by the delivery of recently developed standards and tools that support the creation and delivery of web services.

Heretofore, the primary focus of web service, software vendor, and other developers has been supporting providers and getting their specific web services up and running, as well as supporting customers in finding and accessing services. Following the implementation and support of the web services provided by a company, however, attention quickly shifts from creation, and delivery of these web services, to the management of same. As companies diversify in the types and numbers of web services which are being delivered, tools are needed to support and automate the web service management effort.

Heretofore, some research and development has been directed to these types of management concerns. For example, networks and distributed systems are probably the areas in which the most work on measuring and management issues directed to web-based services has been done. This research effort has resulted in the development of standards and commercial management platforms such as HP OpenView or IBM Tivoli. The mark “HP OpenView” and “IBM Tivoli” are the trademarks of the Hewlett-Packard and IBM Companies, respectively. Still further, the International Telecommunications Union (ITU) in the early 1990's proposed recommendations for measuring distributed software applications and for deriving statistics from collected measures. The basic component of the ITU proposed framework was a metric object. The metric object specifies how a certain application should be monitored by defining how it's attributes should be transformed into measures. The system provides a measurement threshold above which a management application should be notified. Still further, other analysis tools which have been developed have normally included a fixed service model, that is, the specific knowledge of the service model is hard-coded into the analysis tool, and not readily adjustable by the user.

While the applications noted above have worked with some degree of success, these particular applications are normally concerned with performance and monitoring issues only. Further, they provide no specific means by which diverse web services can be managed with a high degree of efficiency. Still further, they normally provide no convenient means by which a user can define a preferred service model and thereafter aggregate a plurality of metrics across different user-defined levels of abstraction.

Recently, several researchers have developed approaches to measure distributed objects running on top of middleware platforms. The majority of these contributions focus on the definition of quality of service (QoS) criteria. These research efforts are relevant to the most common metrics that business users want to analyze. However, these same approaches still fall short of providing a convenient analysis tool for use by those monitoring the delivery of web services. Moreover, the available research, techniques and prior art practices provided heretofore have proven to be less than flexible, and further require substantial modification, in the form of code writing, in order to make them useful in diverse web service applications.

Finally, the contributions provided in the prior art methods and other products provided heretofore in the area of managing the delivery of web services have been focused on the collection of performance measures to support availability and capacity planning, and have not been readily expandable to include other user defined management issues.

A platform and method for monitoring and analyzing data which addresses the perceived shortcomings attendant with the prior art practices utilized heretofore is the subject matter of the present application.

### SUMMARY OF THE INVENTION

One aspect of the present invention relates to a method for monitoring and analyzing data and which includes creating a user defined data structure; defining a plurality of user defined metrics associated with the user-defined data structure; and aggregating the plurality of metrics at different levels of abstraction by utilizing the user defined data structure.

Another aspect of the present invention relates to a method for monitoring and analyzing data and which includes, creating a user defined service model which is based upon a service, and wherein the service has a plurality of characteristics; defining a measurement logic which relates to the plurality of characteristics of the service; computing a plurality of metrics by utilizing the measurement logic and which relates to the plurality of characteristics of the service; providing a user defined monitoring and analysis request which relates to the plurality of characteristics of the service; determining an aggregation path for the user defined monitoring and analysis request; and aggregating the plurality of metrics across different user defined levels of abstraction and based upon the user defined service model.

Still another aspect of the present invention relates to a method for monitoring and analyzing data which includes, providing a user accessible data repository; creating a user defined data structure within the data repository and which relates to a service having a plurality of characteristics; defining within the user defined data structure a client resource, and a service provider resource; defining within the user defined data structure, a conversation which can be conducted between the client resource and the service provider resource, and wherein the conversation includes a state, and a state transition; defining a measurement logic which relates to the plurality of characteristics of the service; computing a plurality of metrics by utilizing the measurement logic, and which relates to the plurality of characteristics of the service; providing a user-defined monitoring and analysis request, and which relates to the plurality of characteristics of the service; determining an aggregation path for the user defined monitoring and analysis request; conducting a conversation between the client resource and the service provider resource by invoking an operation provided by the service provider resource; and aggregating the plurality of metrics across different user-defined levels of abstraction and based upon the user defined data structure.

Still another aspect of the present invention relates to a platform for monitoring and analyzing data and which includes a data repository having a user defined data structure, and which relates to a service having a plurality of characteristics, and wherein the data structure further includes a client resource, and a service provider resource, and wherein a conversation is defined within the data structure and which can be conducted between the client resource, and the service provider resource; a graphic user interface coupled in data exchanging relation relative to the data repository, and wherein the graphic user interface can access meta-information which permits the graphic user interface to be aware of the plurality of characteristics of the service, and wherein a user may submit by way of the graphic user interface a monitoring and analysis request which relates to the plurality of characteristics of the service; a measurement logic which relates to the plurality of characteristics of the service; a plurality of metrics computed by way of the of the measurement logic, and which relates to the plurality of characteristics of the service; a monitoring and analysis engine coupled in data exchanging relation relative to the graphic user interface, and the data repository, and which receives the monitoring and analysis request provided by the graphic user interface, and which determines an aggregation path for the monitoring and analysis request; and a data input manager which allows a user to define the data structure of the data repository, the characteristics of the service, and the conversation which can be conducted between the client resource, and the service provider resource, and wherein following the submission of the a monitoring and analysis request, the conversation is conducted, and which causes the client resource to invoke an operation which is provided by the service provider resource, and wherein the monitoring and analysis engine utilizes the aggregation path to aggregate the plurality of metrics across different user defined levels of abstraction based upon the monitoring and analysis request.

Another aspect of the present invention relates to a computer readable media bearing computer software that, when loaded into a general purpose computer, causes the computer to implement a method for analyzing data, and which includes, creating a user-defined service model which is based upon a service; defining a measurement logic which relates to the service; computing a plurality of metrics by utilizing the measurement logic, and which relate to the service; providing a user-defined monitoring and analysis request which relates to the service; and aggregating the plurality of metrics which relate to the service across different user-defined levels of abstraction based upon the user-defined monitoring and analysis request.

Yet a further aspect of the present invention relates to a platform for monitoring and analyzing data, and which includes means for defining a data repository having a source of data which relates to a service; means for providing a user interface coupled in data exchanging relation relative to the data repository; data engine means for monitoring and analysis of the source of data; and data input means coupled in data exchanging relation relative the data repository.

These and other aspects of the present invention will be discussed in greater detail hereinafter.

### DESCRIPTION OF THE DRAWINGS

Preferred embodiments of the invention are described below with reference to the following accompanying drawings.

FIG. 1 is a greatly simplified schematic drawing illustrating the data model of the present invention.

FIG. 2 is a greatly simplified schematic diagram which shows the relationship of the present invention to several user interfaces.

### DETAILED DESCRIPTION OF THE INVENTION

This disclosure of the invention is submitted in furtherance to the constitutional purposes of the U.S. Patent Laws to promote the progress of science and useful arts.

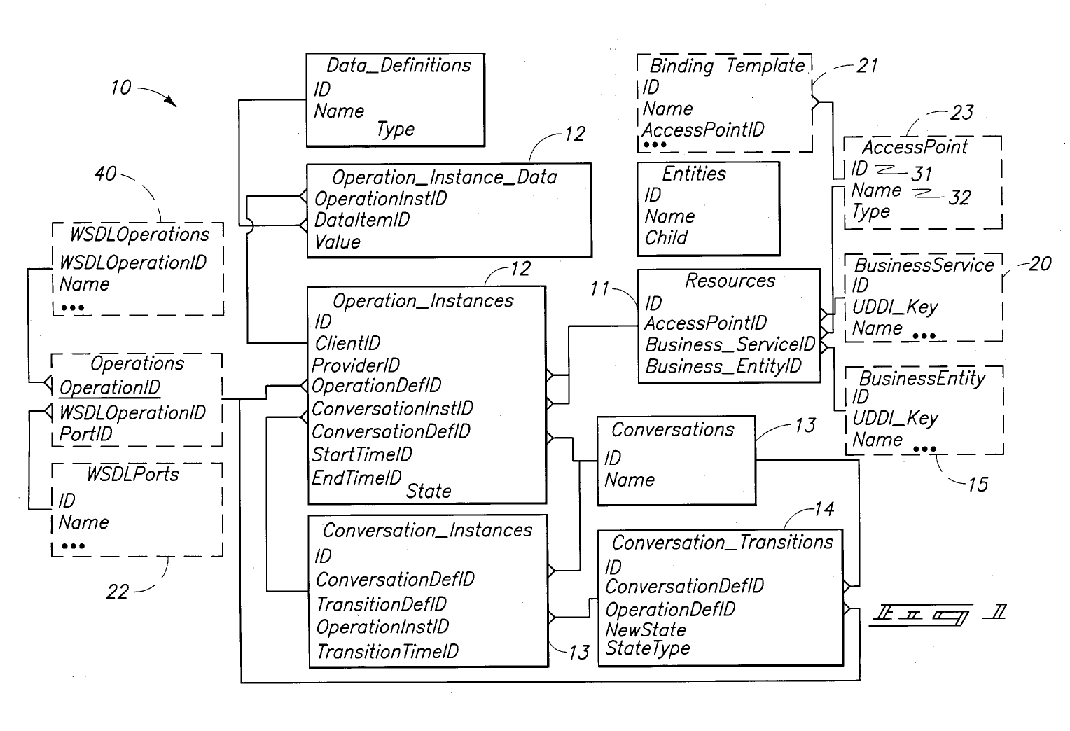

Referring now to FIG. 1 the platform and method for monitoring and analyzing data, such as web service data derived from diverse web services is generally indicated by the numeral 10. As seen therein, it should be understood that the platform 10, as will be hereinafter described, makes very few and mostly general assumptions regarding the service model, that is, the properties of the web services, and how they are structured. Therefore, the platform 10 as described hereinafter, and the assumptions utilized with same, are normally compatible with virtually any service model. As seen in FIG. 1, the platform 10 only assumes that resources 11 (acting as clients), invoke operations 12, which are provided by other resources, and which further act as service providers. The resources 11 and operations 12 are characterized in the platform 10 by unique identifiers. As should be understood, operation 12 invocations may include input/output parameters; invoking sequences of operations; and/or invoking composite operations. Still further, it should be understood that resources 11 (acting as clients) may conduct conversations 13. These conversations 13 may be characterized by various states such as sequences of operations as noted above, or composite operations as will be described below. An example of some of these states may include, for example, in negotiation, offer accepted, or offer rejected; or state transitions 14 that are caused by client's operation invocations. These may include for example, the purchase of a better service. Still further, these state transitions 14 may also include autonomous service provider/initiated transitions. An example of this transition might be a time-out which leads to a conversation 13 into a timed-out state.

As noted above, the operations 12 may be composite, that is they may be executed by invoking other operations which are offered by the same or a different service providers. In the present platform 10, conversation models 13 are fundamentally different from composition models. Conversation models have the purpose of defining the external behavior of a service and/or restricting in particular the order in which operations 12 can be invoked. In the present platform 10, the composition models permit the specification of operation 12 implementations in terms of combinations of other operations. In this example, as discussed above, combinations of operations are analogous to business processes with the peculiarity that the process activities are in fact web service operations.

As illustrated in FIG. 1, the base model for the present platform and method 10 is represented by boxes which are depicted in solid lines. Still further, the boxes which are outlined in dashed lines represent a user definable service model which may operably couple in data exchanging relation with the base model. As should be understood, the present platform and method 10 provides a convenient means whereby a user may dynamically define a data repository, as will be described hereinafter, and thereafter perform a user defined analysis of the data repository across various user defined levels of abstraction.

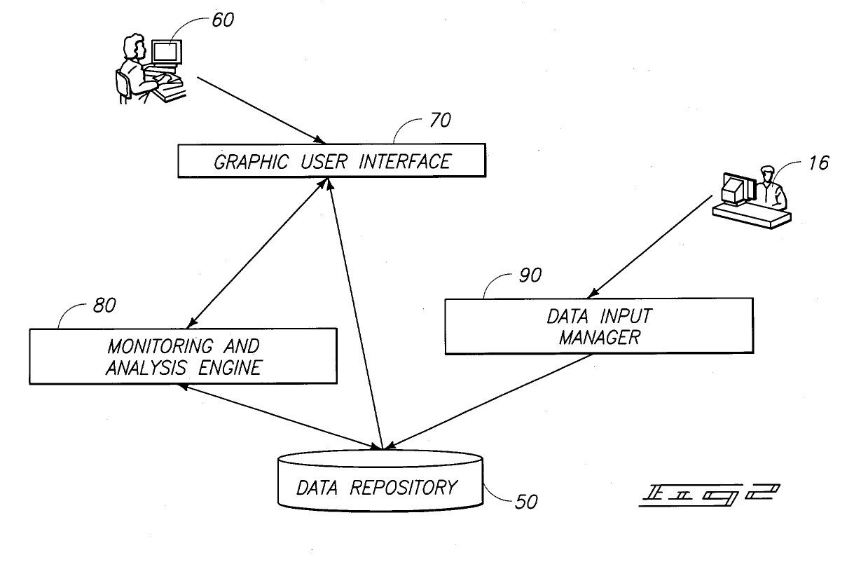

As seen in FIG. 1, the base model of the platform 10 (which is shown by the boxes outlined in solid lines) includes simple entities 15 on which a user may define and analyze metrics. As should be appreciated however, in many cases users can benefit from an enhanced service model which includes a variety of different entities each of which has its own properties. For example, if a company has adopted the UDDI (Universal Description Discovery of Integration) and WSDL (Web Services Description Language) standards and has structured its services accordingly, it may need to analyze and consider web service execution data according to the UDDI or WSDL perspectives. As seen in FIG. 2, the present invention provides a user 16 with a convenient means for permitting this further analysis. As will be appreciated from studying FIGS. 1 and 2, the present platform and method allows a user 16 to define the model on which they base their services in order to permit the definition of characteristics that can later be utilized to define service metrics and the metric computational logic utilized with same. The metrics and computation logic as employed with this method and platform will be discussed hereinafter. As a general matter however, the platform 10 as shown provides a method for monitoring and analyzing data which includes creating a user defined data structure; defining a plurality of user defined metrics associated with the user defined data structure; and thereafter aggregating the plurality of metrics at different levels of abstraction by utilizing the user-defined data structure.

In an effort to illustrate how the platform 10 can be applied to a given service model, FIG. 1 shows the platform 10 which operates in combination with a model taken from UDDI and endowed with WSDL specifications for those aspects of the model not covered by UDDI. While that which is illustrated in FIG. 1 is considered a “default” model which will normally be delivered with the platform 10 for commercial use, it should be understood that other default models can be developed and which can be utilized with the platform 10 with equal success. Therefore, what is shown in FIG. 1 is illustrative only of the present invention as utilized with a given service model. As will be recognized, the UDDI, and WSDL are the leading standard protocols in the web service space. In this regard, UDDI allows the specification of business or service properties, while WSDL is used for describing the service interface.

In UDDI, service providers are represented by business entities 15 consisting of a universally unique identifier (UUID). In this regard, the business entities 15 are identified by a name and by reference to a taxonomy, and by identification schemes for identifying and classifying entities in different semantic contexts. An example of this identification would be the Duns & Bradstreet identification number. A business entity can also offer a number of business services 20 and which are also characterized by a UUID and a name. Each business service can have one or more bindings 21 corresponding to various implementations of a service and characterized by a web page location, as well references to taxonomy and identification schemes. These identifications readily identify and classify the bindings' properties in different contexts. In the present invention 10 as shown in FIG. 1, binding definitions 21 typically (but not necessarily) include references to the interfaces and conversations 13 which they support.

Although the UDDI allows the specification of references to interface description, it does not provide an interface description language. WSDL provides this interface description language. In particular, in WSDL an interface 40 is characterized by the set of operations that can be input/output. More specifically, clients' invoke an operation 12 and the service sends a reply, such as input only, output only, (that is, to model events which are notified by the service); or output/input, (that is to model operations initiated by a service) as will be described hereinafter. As will be appreciated, WSDL operations can have XML parameters and whose structure is defined by XML schemes. As seen in FIG. 1 WSDL operations 40 can be grouped into ports 22. A binding 21 can implement several ports 22.

In order to implement the present platform 10, a user 16 must specify within a data repository, as will be discussed hereinafter, a set of entities 15. For example, the bindings 21, business entity 15, and the business service 20 are examples of entities (and which are represented by dashed boxes), and which define the characteristic of the resources 11 providing services. Objects that belong to a business entity 14 are hereinafter referred to as elements. For example, if a user 16 of the present platform 10 had defined an entity called business service 20, the category “employee reimbursement” would be viewed as an element of the entity business service 20. Each element is characterized by a unique identifier, a name, and an arbitrary user defined set of properties. As illustrated in FIG. 1, business entities 15 can be structured into “part-of hierarchies.” For example, the platform 10 as shown in FIG. 1 shows that UDDI includes a hierarchy having at one level a business entity, another level business services 20, and finally an access point 23. In WSDL, an operation 12 belongs to one or more ports 22. In the arrangement as shown in FIG. 1 the hierarchies are driven by the overriding aggregation needs of the user 16 who is defining same. In this regard, a user only needs to specify specific hierarchies according to how they wish to finally aggregate information. A given service model is specified by XML documents that list the name of the different business entities 20 of the service model being defined at the root of each tree. The present method and platform 10 only permits a bottom-up, tree-shaped hierarchy with business entities 15 being located at the base, or root of each tree. This particular feature of the present invention makes the analysis simpler in that it provides a unique way, or aggregation path by which aggregations may be collected from a location along the tree from the “roots” to the “leaves.”

This same XML document which provides the list of the name of the different business entities 15, also contains an implementation of the present platform 10. The language utilized in the implementation can be whatever language is supported by a data repository 50 as seen FIG. 2. The present method and platform of the invention works independently from the specific data repository 50 being utilized. For example, in the case of relational repositories, the language would be SQL. The SQL is used to create a user 16 defined data structure contained within the data repository 50 and which contains the business entities 15 and other objects that are part of the extended service model that another user 60 wishes to monitor and otherwise analyze. In the present arrangement as seen in FIGS. 1 and 2, the creation of the user 16 defined data structure would include the creation of at least one table for each business entity 15. This table must have the same name as the business entity 15 and must have a numeric primary key, that is, it is linked to the table of the service model for which it extends. Still further, this table will normally contain a name attribute. For example as seen in FIG. 1, to define an access point 23 entity, a user would need to create an access-point table that has at least a primary key or identification 31 and a name 32. Furthermore in the platform 10 as shown, it should be understood that since a binding 21 characterizes the respective service providers, the resource table, as referenced above, must be extended with an attribute or access point identification 31 that allows referencing of each resource to the access point to which it belongs. It should be further understood that other tables with different user defined structures as well as other database objects may be defined at the user's leisure within the implementation part of the XML document. It will be recognized however, that since the platform 10 does not have knowledge of such items, it will not be able to perform an analysis on them, although it will still be able to compute metrics, as will be described below, if a user provides the appropriate computation logic, as will be discussed hereinafter.

An example of such XML document and SQL code is provided below:

<extended_model>
<Entity>

<name> access_point </name>
<child> resources </child>

<Entity>
<Entity>

<name> business_service <name>
<child> access_point </child>

<Entity>
<Entity>

<name> business_entity</name>
<child> busisnes_service </child>

<Entity>
<implementation>
CREATE TABLE ESM_BINDING_TEMPLATE (

| | |
|---|---|
| ID | NUMBER PRIMARY KEY, |
| UDDI_KEY | VARCHAR2 (512) NOT NULL, |
| BUSINESS_SERVICE_ID | NUMBER, |
| ACCES_POINT_ID | NUMBER, |
| HOSTING_REDIRECTION_ID | NUMBER, |
| NAME | VARCHAR2 (512) |

)
TABLESPACE WSM_SERVICE_MODEL_TBS
CACHE
STORAGE (BUFFER_POOL KEEP)
;
CREATE TABLE ESM_ACCESS_POINT (

| | |
|---|---|
| ID | NUMBER PRIMARY KEY, |

| | |
|---|---|
| NAME | VARCHAR2(512), |

| | |
|---|---|
| TYPE | VARCHAR2(512) |

)
TABLESPACE WSM_SERVICE_MODEL_TBS
CACHE
STORAGE (BUFFER_POOL KEEP)
;
CRATE TABLE ESM_BUSINESS_SERVICE (

| | |
|---|---|
| ID | NUMBER PRIMARY KEY, |

| | |
|---|---|
| UDDI_KEY | VARCHAR2 (512) |
| NAME | VARCHAR2 (512) |

)
TABLESPACE WSM_SERVICE_MODEL_TBS
CACHE
STORAGE (BUFFER_POOL KEEP)
;
CREATE TABLE ESM_BUSINESS_ENTITY (

| | |
|---|---|
| ID | NUMBER PRIMARY KEY, |

| | |
|---|---|
| UDDI_KEY | VARCHAR2 (512) |
| NAME | VARCHAR2 (512), |
| DESCRIPTION | VARCHAR2 (2048) |

| ) | |
|---|---|
| TABLESPACE WSM_SERVICE_MODEL_TBS | |
| CACHE | |
| STORAGE (BUFFER_POOL KEEP) | |
| ; | |
| CRATE TABLE ESM_UDDI_BAGS ( | |
| ELEMENT_ID | NUMBER, |
| ENTITY_ID | NUMBER, |

| | |
|---|---|
| REFERENCE_TYPE | NUMBER, --0+CATEGORY, 1+INDENTIFIER |

| | |
|---|---|
| T_MODEL_ID | VARCHAR2 (512) NOT NULL, |
| KEY_NAME | VARCHAR2 (512), |
| KEY_VALUE | VARCHAR2 (2048), |

)
TABLESPACE WSM_SERVICE_MODEL_TBS
CACHE
STORAGE (BUFFER_POOL KEEP)
;
CREATE TABLE ESM_T_MODELS (

| | |
|---|---|
| ID | NUMBER PRIMARY KEY, |

| | |
|---|---|
| UDDI_KEY | VARCHAR2 (512) NOT NULL, |

| | |
|---|---|
| NAME | VARCHAR2 (512), |

| | |
|---|---|
| DESCRIPTION | VARCHAR2 (2048), |
| OVERVIEW_DOC | VARCHAR2 (2048) |

)
TABLESPACE WSM_SERVICE_MODEL_TBS
CACHE
STORAGE (BUFFER_POOL KEEP)
;
</implementation>
</extended_model>

As discussed above, tables that are part of the platform 10 are shown with solid borders and tables that are part of the user defined or plugged in model have been depicted in dash borders. As will be appreciated from a study of FIG. 1, only a few tables of the user defined (plugged in) model are shown in order to demonstrate the overall attributes of the present invention 10. In reality, the present invention is much more complex. In this regard, FIG. 1 depicts a resulting user defined data structure that can store operation 12 and conversation 13 execution data. As will be recognized, these tables allow logging of the client and service provider identifications. As should be understood, if the operation 12 is actually executed as part of a composite operation, then it can also hold a reference to the invoking (parent) operation.

Aggregations are defined by another XML document, that specifies the measured entity (e.g., a service executions); the base for the aggregations (e.g., assume that we want to see service instance metrics grouped by service type) and the code that is required to determine the service type for a given service execution. The platform 10 will match this information with the metric data in order to group metric data appropriately.

An example of aggregation document is as follows:

<aggregation>
<base_entity>

<name> service_instance </name>

</base_entity>
<aggregation_entity>

<name> service_type </name>

<aggregation_entity>
<implementation>
INSERT INTO CK_AGGREGATIONS
SELECT B.ID, A.ID,
‘SELECT SI. ID, S.SERVERITY FROM SERVICE_INSTANCE SI, SERVICE S
WHERE SI.SERVICE_ID=S.ID’
FROM ENTITIES B, ENTITIES A
WHERE B.EXTENDED_NAME=‘SERVICE INSTANCE’
AND A.EXTENDED_NAME=‘SERVICE TYPE’
</implementation>
</aggregation>

The platform 10 as seen in FIGS. 1 and 2 includes a user defined data repository 50. Still further the platform 10 includes a graphic user interface 70 which is coupled in data exchanging relation relative to the data repository 50. Still further, the platform 10 includes a monitoring and analysis engine 80 which is coupled in data exchanging relation relative to the graphic user interface 70 and the data repository 50. In the arrangement as shown, a data input manager 90 is provided and which is coupled in data exchanging relation relative to the data repository 50. As will be appreciated from a study of FIGS. 1 and 2, the platform 10 permits a user 16 to define a plurality of business metrics (not shown) and which are used for measuring and analyzing web service data executions. In this regard, the plurality of metrics are computed by utilizing a user defined measurement logic and which relates to the service model defined by the user 16. In the arrangement as shown in FIG. 2, the monitoring and analysis engine is capable of aggregating the plurality of metrics across different user defined levels of abstraction based upon the user-defined service model. As illustrated in FIG. 2, the data input manager facilitates the creation of an entity 15, and an entity hierarchy, as earlier described, within the user defined data repository 50. The user defined data repository 50 includes a user defined data structure having a plurality of portions. In the arrangement as shown, the data input manager 90 allows a user 16 to verify the existence of individual portions of the defined data structure within the data repository 50.

More specifically, the platform 10 for monitoring and analyzing data as shown in FIGS. 1 and 2 includes a data repository 50 having a user 16 defined data structure and which relates to a service having a plurality of characteristics. The data structure further includes a client resource and a service provider resource 11 and wherein a conversation 13 is defined within the data structure and which can be conducted between the client resource and the service provider resource. A graphic user interface 70 is provided and is coupled in data exchanging relation relative to the data repository 50. The graphic user interface 70 includes or allows access to meta-information which permits the graphic user interface to be aware of the plurality of characteristics of the service. A user 60 may submit, by way of the graphic user interface, a monitoring and analysis request which relates to the plurality of characteristics of the service. A measurement logic, which relates to the plurality of characteristics of the service, is defined by the user 16. A plurality of metrics are computed by way of the measurement logic and which relates to the plurality of characteristics of the service. A monitoring and analysis engine 80 is provided and which is coupled in data exchanging relation relative to the graphic user interface 70 and the data repository 50. The monitoring and analysis engine receives the monitoring and analysis request provided by the graphic user interface 70, and thereafter determines an aggregation path for the monitoring and analysis request. As earlier discussed, a data input manager which is provided allows a user 16 to define the data structure of the data repository 50, the characteristics of the service, and the conversation 13 which can be conducted between the client resource and the service provider resource. In the arrangement as shown, and following the submission of the monitoring and analysis request by the user 60, the conversation 13 is conducted and which causes the client resource to invoke an operation which is provided by the service provider resource. When this is accomplished, the monitoring and analysis engine uses the aggregation path to aggregate the plurality of metrics across different user defined levels of abstraction based upon the monitoring and analysis request. In the arrangement as shown, the user defined data structure includes an entity and an entity hierarchy which are provided by way of the data input manager 90. Still further and as discussed earlier, the operation invoked by the client resource may include invoking sequences of operations, composite operations, and/or utilizing input/output parameters.

The platform 10 as seen in FIGS. 1 and 2 provides a method for monitoring and analyzing data which includes providing a user accessible data repository 50, and creating within the user defined data repository a user defined data structure which relates to a service having a plurality of characteristics. The method further includes defining within the user defined data structure at least one entity 15 and one entity hierarchy. Still further, the method allows a user 16 to define within the user defined data structure a client resource, and a service provider resource 11. Still further, the method permits a user 16 to define within the user defined data structure a conversation 13 which can be conducted between the client resource and the service provider resource. The conversation includes a state and a state transition 14. The method further permits a user 16 to define a measurement logic which relates to the plurality of characteristics of the service. Additionally, the method includes computing a plurality of metrics by utilizing the measurement logic and which relates to the plurality of characteristics of the service defined by the user 16. The method of the present invention permits a user 16 to define and submit a monitoring and analysis request and which relates to the plurality of characteristics of the service. Following submission of the monitoring and analysis request, an aggregation path is selected for the user defined monitoring and analysis request. Still further, the method includes conducting the conversation 13 between the client resource and the service provider resource and aggregating the plurality of metrics across different user-defined level of abstraction and based upon the user defined data structure as provided in the data repository 50. In the present method, invoking an operation may result in invoking sequences of operations, composite operations, or providing input/output parameters as earlier discussed.

One aspect of the present invention relates to a computer readable media bearing computer software that, when loaded into a general purpose computer, causes the computer to implement a method for analyzing data, which includes, creating a user-defined service model which is based upon a service; defining a measurement logic which relates to the service; computing a plurality of metrics by utilizing the measurement logic and which relate to the service; providing a user-defined monitoring and analysis request which relates to the service; and aggregating the plurality of metrics which relate to the service across different user-defined levels of abstraction based upon the user-defined monitoring and analysis request. To implement this method, the platform 10 for monitoring and analyzing data includes a means for defining a data repository 50 having a source of data which relates to the service; means for providing a user interface 70 coupled in data exchanging relation relative to the data repository; a data engine means 80 for monitoring and analyzing the source of data; and data input means 90 coupled in data exchanging relation relative the data repository 50 and which permits a user 16 to define the data structure within the data repository.

Therefore the present invention provides a convenient method for monitoring and analyzing data which includes creating a user defined data structure; defining a plurality of user-defined metrics associated with the user-defined data structure; and aggregating the plurality of metrics at different levels of abstraction by utilizing the user-defined data structure. As presently described, the user defined data structure relates to web-based services and may further include a user defined web-based service model. As will be recognized, the present invention provides a framework that allows a web service management tool to operate on top of a user defined service model. The present platform is applicable to virtually any company and any business domain even if companies have very different web service models. The present invention also provides an analysis and management tool which does not need to be modified when a new and previously unknown service model is defined. As earlier discussed, previous prior art practices have on the one hand either assumed a specific service model, which has been hard coded into the tool, or which requires significant configuration efforts if a service different from the built-in one is defined. The present invention provides a very flexible tool for use in the web service environment inasmuch as the web service landscape will not be mature for some period of time. Currently, companies which offer web services have specific service models and unique management concerns or issues which confront those services. Consequently, the ability to manage their own web service models according to their own, unique user defined structure provides advantages not possible heretofore.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A method for monitoring and analyzing data, comprising:
creating a user defined data structure;
defining a plurality of user-defined metrics associated with the user-defined data structure; and
aggregating the plurality of metrics at different levels of abstraction by utilizing the user-defined data structure.

2. A method as claimed in claim 1, and wherein the user defined data structure relates to web-based services.

3. A method as claimed in claim 1, and wherein the user defined data structure comprises a user defined web-based service model.

4. A method as claimed in claim 1, and wherein the user defined data structure is a web-based service model, and wherein the method further comprises:
defining a plurality of resources which relate to individual properties of the web-based service; and
invoking an operation of at least one of the plurality of resources.

5. A method as claimed in claim 4, and wherein invoking an operation further comprises providing input/output parameters.

6. A method as claimed in claim 4, and wherein invoking an operation further comprises invoking sequences of operations.

7. A method as claimed in claim 4, and wherein invoking an operation further comprises invoking composite operations.

8. A method as claimed in claim 1, and wherein the user defined data structure is a web-based service model, and wherein the method further comprises:
defining in the web-based service model at least one entity, and wherein at least one of the plurality of metrics relates to the at least one entity, and
analyzing the entity by way of the at least one metric.

9. A method as claimed in claim 1, and wherein the user defined data structure is a web-based service model, and wherein the method further comprises:
defining at least one entity in the web-base service model;
providing a data repository, and defining at least one entity hierarchy in the data repository; and
implementing the web-based service model by accessing the data repository.

10. A method as claimed in claim 9, and wherein aggregating the plurality of metrics at different level of abstraction further comprises:
preparing a user defined monitoring and analysis request;
determining an aggregation path for the user defined monitoring and analysis request; and
computing the user defined aggregation of the plurality of metrics by way of the aggregation path.

11. A method for monitoring and analyzing data, comprising:
creating a user-defined service model which is based upon a service, and wherein the service has a plurality of characteristics;
defining a measurement logic which relates to the plurality of characteristics of the service;
computing a plurality of metrics by utilizing the measurement logic, and which relates to the plurality of characteristics of the service;
providing a user-defined monitoring and analysis request which relates to the plurality of characteristics of the service;
determining an aggregation path for the user defined monitoring and analysis request; and
aggregating the plurality of metrics across different user-defined levels of abstraction and based upon the user defined service model.

12. A method as claimed in claim 11, and wherein creating the user-defined service model further comprises:
providing a user accessible data repository; and
creating a user defined data structure within the data repository.

13. A method as claimed in claim 12, and wherein creating a user defined data structure further comprises:
defining at least one entity in the user defined data structure;
defining at least one entity hierarchy within the user defined data structure.

14. A method as claimed in claim 11, and further comprising:
defining within the user defined service model a plurality of resources and which relate to the characteristics of the service; and
invoking an operation of at least one of the plurality of resources.

15. A method as claimed in claim 11, and wherein creating the user defined service model further comprises:
defining within the user defined service model a client resource, and a service provider resource; and
conducting a conversation between the client resource and the service provider resource.

16. A method as claimed in claim 15, and wherein conducting the conversation between the client resource and the service provider resource further comprises:
invoking an operation provided by the service provider resource.

17. A method as claimed in claim 16, and wherein invoking an operation further comprises:
conducting a sequence of operation invocations with the service provider resource.

18. A method as claimed in claim 15, and wherein before conducting the conversation, the method further comprises defining the conversation.

19. A method as claimed in claim 18, and wherein defining the conversation further comprises:
defining a state of the conversation; and
defining a state transition of the conversation.

20. A method as claimed in claim 19, and wherein conducting the conversation between the client resource and the service provider resource further comprises:
invoking an operation provided by the service provider resource to cause the state transition of the conversation.

21. A method for monitoring and analyzing data, comprising:
providing a user accessible data repository;
creating a user defined data structure within the data repository and which relates to a service having a plurality of characteristics;
defining within the user defined data structure at least one entity, and one entity hierarchy;
defining within the user defined data structure a client resource and a service provider resource;
defining within the user defined data structure a conversation which can be conducted between the client resource and the service provider resource, and wherein the conversation includes a state, and a state transition;
defining a measurement logic which relates to the plurality of characteristics of the service;
computing a plurality of metrics by utilizing the measurement logic, and which relates to the plurality of characteristics of the service;
providing a user defined monitoring and analysis request and which relates to the plurality of characteristics of the service;
determining an aggregation path for the user defined monitoring and analysis request;
conducting the conversation between the client resource and the service provider resource by invoking an operation provided by the service provider resource; and
aggregating the plurality of metrics across different user-defined level of abstraction and based upon the user defined data structure.

22. A method as claimed in claim 21, and wherein invoking an operation further comprises invoking sequences of operations.

23. A method as claimed in claim 21, and wherein invoking an operation further comprises invoking composite operations.

24. A method as claimed in claim 21, and wherein invoking an operation further comprises providing input/output parameters.

25. A platform for monitoring and analyzing data comprising:
a user defined data repository;
a graphic user interface coupled in data exchanging relation relative to the data repository;
a monitoring and analysis engine coupled in data exchanging relation relative to the graphic user interface and the data repository; and
a data input manager coupled in data exchanging relation relative to the data repository.

26. A platform as claimed in claim 25, and wherein the user defined data repository further comprises:
a user defined data structure having at least one entity, and an entity hierarchy, and wherein a service model having a plurality of characteristics is created within the user defined data structure.

27. A platform as claimed in claim 26, and wherein the user defined data structure further comprises:
a measurement logic which relates to the plurality of characteristics of the service model; and
a plurality of metrics which are computed by utilizing the measurement logic, and which relate to the plurality of characteristics of the service.

28. A platform as claimed in claim 25, and wherein the user defined data repository further comprises:
a user defined data structure which defines a service model having a plurality of characteristics, and wherein the service model further defines a client resource and a service provider resource, and wherein a conversation is defined within the user defined data structure and which can be conducted between the client resource and the service provider resource.

29. A platform as claimed in claim 28, and wherein the conversation, when conducted between the client resource and the service provider resource, results in an operation being invoked by the service provider resource.

30. A platform as claimed in claim 25, and wherein the user defined data repository further comprises:
a user defined data structure which defines a service model having a plurality of characteristics, and wherein the graphic user interface displays at least a portion of the service model.

31. A platform as claimed in claim 25, and wherein the user defined data repository further comprises:
a measurement logic which relates to a user defined service model; and
a plurality of metrics which are computed by utilizing the measurement logic and which relate to the service model, and wherein the monitoring and analysis engine aggregate the plurality of metrics across different user-defined levels of abstraction based upon the user defined service model.

32. A platform as claimed in claim 25, and wherein the data input manager facilitates the creation of an entity and an entity hierarchy within the user defined data repository.

33. A platform as claimed in claim 26, and wherein the user defined data repository includes a user defined data structure having a plurality of portions, and wherein the data input manager allows a user to verify the existence of individual portions of the defined data structure.

34. A platform for monitoring and analyzing data, comprising:
a data repository having a user defined data structure, and which relates to a service having a plurality of characteristics, and wherein the data structure further includes a client resource, and a service provider resource, and wherein a conversation is defined within the data structure and which can be conducted between the client resource, and the service provider resource;
a graphic user interface coupled in data exchanging relation relative to the data repository, and wherein the graphic user interface includes meta-information which permits the graphic user interface to be aware of the plurality of characteristics of the service, and wherein a user may submit by way of the graphic user interface a monitoring and analysis request which relates to the plurality of characteristics of the service;
a measurement logic which relates to the plurality of characteristics of the service;
a plurality of metrics computed by way of the of the measurement logic, and which relates to the plurality of characteristics of the service;
a monitoring and analysis engine coupled in data exchanging relation relative to the graphic user interface and the data repository, and which receives the monitoring and analysis request provided by the graphic user interface, and which determines an aggregation path for the monitoring and analysis request; and
a data input manager which allows a user to define the data structure of the data repository, the characteristics of the service, and the conversation which can be conducted between the client resource, and the service provider resource, and wherein following the submission of the a monitoring and analysis request, the conversation is conducted, and which causes the client resource to invoke an operation which is provided by the service provider resource, and wherein the monitoring and analysis engine utilizes the aggregation path to aggregate the plurality of metrics across different user defined levels of abstraction based upon the monitoring and analysis request.

35. A platform as claimed in claim 34, and wherein the user defined data structure further comprises an entity and an entity hierarchy, and which is provided by way of the data input manager.

36. A platform as claimed in claim 34, and wherein the operation invoked by the client resource comprises invoking sequences of operations.

37. A platform as claimed in claim 34, and wherein the operation invoked by the client resource comprises invoking composite operations.

38. A platform as claimed in claim 34, and where the operation invoked by the client resource comprises utilizing input/output parameters.

39. A computer readable media bearing computer software that, when loaded into a general purpose computer, causes the computer to implement a method for analyzing data, comprising:
creating a user-defined service model which is based upon a service;
defining a measurement logic which relates to the service;
computing a plurality of metrics by utilizing the measurement logic and which relate to the service;
providing a user-defined monitoring and analysis request which relates to the service; and
aggregating the plurality of metrics which relate to the service across different user-defined levels of abstraction based upon the user-defined monitoring and analysis request.

40. A platform for monitoring an analyzing data, comprising:
means for defining a data repository having a source of data which relates to a service;
means for providing a user interface coupled in data exchanging relation relative to the data repository;
data engine means for monitoring and analysis of the source of data; and
data input means coupled in data exchanging relation relative the data repository.
